(19) United States
(12) Patent Application Publication
(10) Pub. No.: US 2009/0084276 A1
(43) Pub. Date: Apr. 2, 2009

(54) Apparatus for reducing volume of a beverage container and apparatus for separating beverage containers

(75) Inventor: Kazuo Akiyama, Kawasaki-shi (JP)

Correspondence Address: KANESAKA BERNER AND PARTNERS LLP, 1700 DIAGONAL RD, SUITE 310, ALEXANDRIA, VA, 22314-2848, US

(73) Assignee: Kazuo AKIYAMA, Kawasaki-shi (JP)

(21) Appl. No.: 12/232,358

(22) Filed: Sep. 16, 2008

(30) Foreign Application Priority Data
Oct. 1, 2007 (JP) 2007-257949

(51) Int. Cl. B30B 9/00; B30B 5/02

(52) U.S. Cl. 100/91; 100/211

(57) ABSTRACT

An apparatus for separating beverage containers according to the present invention has a vibrating screen arranged with a slope, over which an apparatus for reducing the volume of a beverage container is installed. The volume reduction apparatus has a pair of tires which have a fixed center distance therebetween and are in pressure contact with each other. A plurality of engaging members are circumferentially arranged on the outer periphery of one of the tires. Empty cans and PET bottles are fed to and crushed in the pressure contact area in the volume reduction apparatus. The separation apparatus screens out the crushed empty cans during vibration transfer, based on a difference in thickness between the crushed empty cans and the crushed PET bottles. Empty cans passed unscreened and the PET bottles are separated by a weir member, utilizing a difference in the height direction. The crushed cans are simply let through, and the crushed PET bottles are guided to either side of the vibrating screen by the weir member and discharged from outlets.

### BACKGROUND OF THE INVENTION

1. Field of the Invention

The present invention relates to an apparatus for reducing volume of a beverage container for pressuring and crushing empty beverage cans and PET bottles in a mixed state in succession, and an apparatus for separating beverage containers for successively separating cans and PET bottles, or beverage containers, that are reduced in volume by the volume reduction apparatus in succession.

2. Description of the Related Art

In one of the flows of resource recovery operations, containers such as empty cans and empty PET bottles are collected, for example, from resource collection boxes or the like which are placed beside beverage vending machines. The collected containers are put into large collection bags in a mixed state, and are collected to one location. A large number of collection bags are then loaded on trucks and collected to the next collection site, where the cans and PET bottles are separated from each other, and the cans are also separated into steel cans and aluminum cans.

In a conventional separation apparatus for separating a mixture of empty cans, empty PET bottles, and the like mechanically, empty cans, PET bottles, and glass bottles are fed to a bottom side of a transfer conveyer which is arranged with a slope. During transfer, steel cans are magnetically absorbed for initial separation by using a steel can separator. An aluminum can separator is then used to produce an eddy current in aluminum cans to be discharged from the transfer conveyor, so that the repulsion between the magnetic field caused by the eddy current and a magnetic field provided at the transfer end of the transfer conveyer flips the aluminum cans forward for selection. The empty glass bottles, PET bottles, and other remainders are then dropped from the transfer conveyor, at which time a blower sends air to blow away the PET bottles of lighter weights for separation from the glass bottles, being collected into respective collection chutes (Japanese Patent Laid-Open Publication No. 2001-334397).

This separation apparatus separates empty cans into steel cans and aluminum cans before crushing, and also separates the empty cans from uncrushed PET bottles.

A conventional volume reduction apparatus for crushing empty cans into reduced volume has a pair of automobile tires each having a horizontal rotating shaft. The tires are rotatably supported with their outer peripheries in contact with each other. One of the tires is driven to rotate in this state, and the other tire follows to rotate. When an empty can is introduced from above into a nip portion where the two tires come into pressure contact with each other, the empty can is nipped and crushed in the nip portion, and the flattened empty can is dropped down. Empty cans fed from above in succession are dropped down in succession (Japanese Patent Laid-Open Publication No. 2005-046845).

The conventional volume reduction apparatus crushes empty cans in succession, while collected empty cans may still contain some of the beverages. When those cans are nipped and crushed in the nip portion, the remaining liquids are scattered over the outer peripheries of the pair of tires to wet the outer peripheries of the tires, with a significant drop in the coefficient of friction to the empty cans. This makes the empty cans introduced to the nip portion slip over the tire surfaces, so that the pair of tires can no longer nip and crush empty cans.

PET bottles have a smaller coefficient of friction to the outer peripheries of the tires. It is therefore even harder for the outer peripheries of the tires to nip PET bottles when wet.

The volume reduction apparatus disclosed in Japanese Patent Laid-Open Publication No. 2005-046845 is configured so that the distance between the surfaces of the pair of tires can be increased when empty cans are nipped in the nip portion, whereby the nip portion is prevented from being clogging with cans. Due to the follower rotation of the other tire, however, the driving force from the driving tire will not reach the follower tire if the distance between the surfaces of the two tires becomes too large. As a result, the follower tire cannot apply sufficient pressure to empty cans that are nipped in the nip portion, failing to crush the empty cans adequately.

The target beverage containers to be crushed by the volume reduction apparatus disclosed in Japanese Patent Laid-Open Publication No. 2005-046845 are empty cans. The inventor has attempted to crush PET bottles in the volume reduction apparatus of this configuration. Since PET bottles are harder to collapse than empty cans, however, the distance between the surfaces of the two tires has widened largely, making it more difficult to crush the PET bottles. Moreover, due to reasons such as the smaller coefficient of friction than that of cans to the tires, it has been even harder to nip the PET bottles into the nip portion when the outer peripheries of the tires are wet.

Note that the selection apparatus disclosed in Japanese Patent Laid-Open Publication No. 2001-334397 for separating a mixture of empty cans and empty PET bottles requires devices such as a blower unit and a magnetic field generator. The entire selection apparatus therefore becomes greater in size and higher in complexity and in price.

In short, the separation apparatus disclosed in Japanese Patent Laid-Open Publication No. 2001-334397 separates empty cans and empty PET bottles before volume reduction. The separated steel cans, aluminum cans, and empty PET bottles are either reduced in volume individually; or the empty cans alone are subjected to volume reduction as in the volume reduction apparatus disclosed in Japanese Patent Laid-Open Publication No. 2005-046845 without the volume reduction of the PET bottles.

### SUMMARY OF THE INVENTION

An object of the present invention is to provide an apparatus for surely reducing volume of a beverage container, capable of crushing empty beverage cans and PET bottles fed in a mixed state in succession even if its pressurizing surfaces for providing a nip portion are wet with water or the like.

Now, the inventor has also found that when empty beverage cans and PET bottles to be separated are subjected to the volume reduction, the empty cans can be flattened into a small thickness, however, the empty beverage PET bottles can be flattened but not with a complete plastic deformation like the empty cans, restoring some of their thickness. Focusing attention on the fact that empty beverage cans and beverage PET bottles have not much difference in outer diameter before crushed but a large difference in thickness after crushed, the inventor has reached the conception of the separation apparatus according to the present invention.

Another object of the present invention is to provide an apparatus for separating beverage containers, which has a simple configuration and is capable of surely separating a mixture of empty beverage cans and beverage PET bottles in succession.

To achieve the foregoing objects of the present invention, an apparatus for reducing volume of a beverage container includes:

a pair of rotators each having a horizontal rotating shaft, the rotators being arranged with a fixed center distance between the rotating shafts so that their outer peripheries are in pressure contact with each other; and

a drive mechanism for driving the pair of rotators individually so as to rotate from above to below in a pressure contact area.

In this configuration, an empty beverage container fed to the pressure contact area between the pair of rotating rotators from above is pressurized and crushed, and is dropped and discharged from the pressure contact area.

Furthermore, the pair of rotators have an elastic body around the rotator bodies each. An engaging member for coming into engagement with the fed container is formed on either one of the rotators so as to protrude outward from the surface of the elastic body.

In another configuration of the apparatus for reducing volume of a beverage container for achieving the foregoing objects of the present invention, the engaging member includes rod-like members extending in a direction of the rotating shaft, the rod-like members being circumferentially arranged at an appropriate pitch.

To achieve the foregoing objects of the present invention, an apparatus for separating beverage containers includes:

a vibrating screen arranged with a slope; and

an apparatus for reducing volume of a beverage container for feeding crushed and volume-reduced cans and PET bottles, or beverage containers, to the vibrating screen, the apparatus being arranged on an upper side of the slope of the vibrating screen.

In this configuration, the vibrating screen includes:

a screen unit formed on a surface for transferring the containers to be transferred by vibration, the screen unit having screen meshes of a size such that crushed beverage cans can be passed through and crushed PET bottles cannot;

a weir member arranged on a lower side of the slope of the vibrating screen, the weir member being set to a pass height such as to allow only the crushed cans that have not fallen into the screen meshes to pass but not the crushed PET bottles, thereby guiding the not-passed PET bottles to be transferred by vibration to a side of the vibrating screen;

a can receiver unit for receiving the crushed cans passed and dropped through the screen meshes; and

an outlet for discharging the crushed PET bottles guided sideways by the weir member out of the vibrating screen.

In another configuration of the selection apparatus for beverage containers for achieving the objects of the present invention, the vibrating screen is vibrated by a vibrator unit with the slope direction as the direction of vibration.

Detailed configurations of the apparatus for reducing volume of a beverage container and the selection apparatus for beverage containers of the invention, the above and other objects and features of the invention will be apparent from the embodiments, described bellow.

### BRIEF DESCRIPTION OF THE DRAWINGS

FIG. 1 is a front view showing an embodiment of the apparatus for reducing volume of a beverage container according to the present invention;

FIG. 2 is a plan view of FIG. 1;

FIG. 3A is a front view showing an embodiment of the apparatus for separating beverage containers according to the present invention, FIG. 3B is a plan view of FIG. 3A, and FIG. 3C is a sectional view taken along the line A-A of FIG. 3B; and

FIGS. 4A and 4B are diagrams showing how the volume reduction apparatus of FIG. 1 is installed on the separation apparatus of FIG. 3A.

### DETAILED DESCRIPTION OF THE PREFERRED EMBODIMENTS

Hereinafter, preferred embodiments of the invention will be described in detail with reference to the drawings.

### First Embodiment

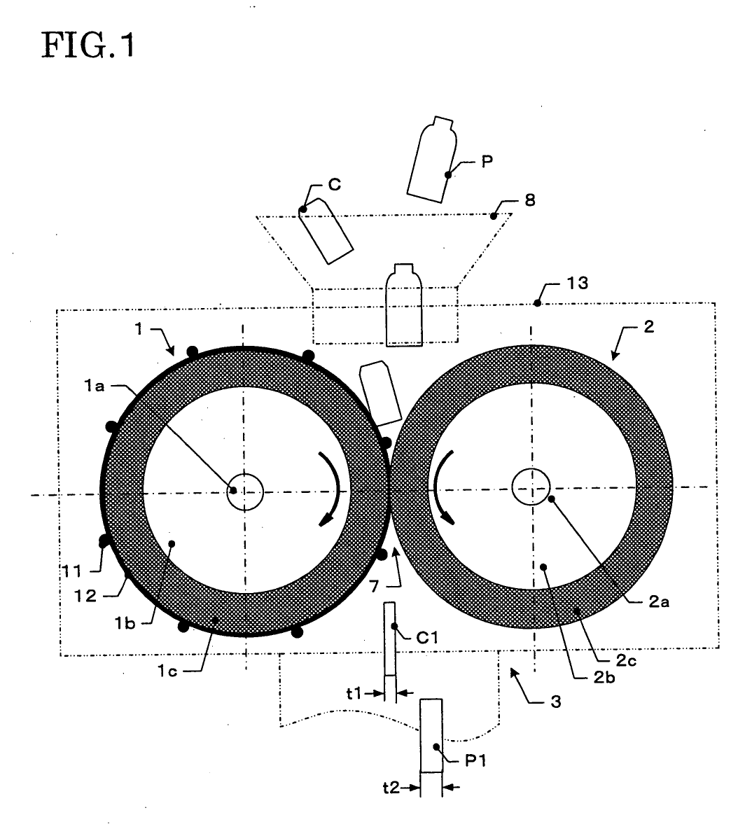

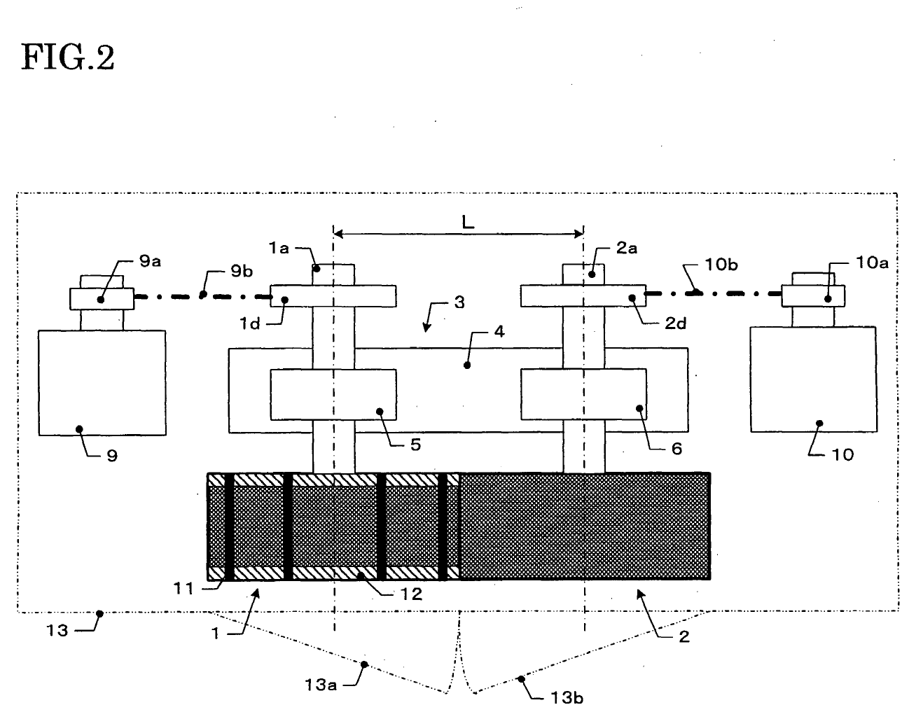

FIGS. 1 and 2 show a first embodiment of the apparatus for reducing volume of a beverage container according to the present invention. FIG. 1 is a front view, and FIG. 2 is a plan view of FIG. 1, both showing a situation where an outside cover in double-dashed lines is removed.

In FIGS. 1 and 2, a first rotator 1 having a horizontal rotating shaft 1a and a second rotator 2 having a horizontal rotating shaft 2a like the first rotator 1 are attached to an apparatus body 3 with their outer peripheries in pressure contact with each other. A bearing 5 for rotatably supporting the rotating shaft 1a of the first rotator 1 and a bearing 6 for rotatably supporting the rotating shaft 2a of the second rotator 2 are fixed to a bearing stand 4 of the apparatus body 3 by not-shown bolts, with a constant center distance L therebetween. Empty cans C made of aluminum or steel and empty PET bottles P, i.e., beverage containers are dropped and fed to a nip portion 7 from a hopper 8 above. The nip portion 7 refers to the pressure contact area between the first rotator 1 and the second rotator 2.

The first rotator 1 and the second rotator 2 are driven to rotate by respective drive units each consisting of a motor and a speed reduction mechanism. A first drive unit 9 drives the first rotator 1 to rotate clockwise as shown in FIG. 1. A second drive unit 10 drives the second rotator 2 to rotate counterclockwise. In the nip portion 7, the first rotator 1 and the second rotator 2 rotate downward, whereby empty cans C and empty PET bottles P dropped and fed from above are crushed and discharged downward.

The first rotator 1 and the second rotator 2 have respective cylindrical rotator bodies 1b and 2b made of metal, around which cylindrical elastic bodies 1c and 2c made of rubber are attached to. The outer peripheries of the elastic bodies 1c and 2c are in pressure contact with each other. The first rotator 1 and the second rotator 2 each have a width such that the nip portion 7 can surely crush an empty can C or an empty PET bottle P regardless of whether longitudinally or sideways. In the present embodiment, the first rotator 1 and the second rotator 2 are automobile tires, with the wheels as the rotator bodies 1b and 2b and the rubber tires as the elastic bodies 1c and 2c.

A plurality of engaging members 11 made of metal are formed in a rod-like shape along the width direction of the tire 1c. These engaging members 11 are laid across the outer periphery of the elastic body (tire) 1c of the first rotator 1, being circumferentially arranged at intervals. A pair of fastening bands 12 are fastened and fixed to both sides of the outer periphery of the tire 1c. The engaging members 11 are fixed at both ends to the fastening bands 12 by welding or the like.

These engaging members 11 come into engagement with empty cans C and empty PET bottles P dropped and fed from above, thereby introducing the engaged empty cans C and empty PET bottles P to the nip portion 7 with reliability. When an empty can C or an empty PET bottle P still having a liquid content is dropped and fed to the nip portion 7 or crushed in the nip portion 7, the surface of the tire 1c can sometimes be wet with this liquid. This lowers the coefficient of friction on the surface of the tire 1c, and makes it impossible to introduce empty cans C and empty PET bottles P to the nip portion 7 by only the frictional force from the surface of the tire 1c. In conventional cases, for example, the empty cans C would remain in the entrance to the nip portion 7, so that empty cans C and empty PET bottles P fed from above in succession are accumulated to make successive crushing and discharge impossible. In the present embodiment, however, the outer periphery of this tire 1c provided with the engaging members 11 which protrude outward from the surface of the tire 1c. Empty cans C and empty PET bottles P fed in succession can thus be introduced to and crushed in the nip portion 7 without fail despite the foregoing drop in the coefficient of friction, and flatly-crushed empty cans C1 and PET bottles P1 can be discharged downward.

The first rotator 1 and the second rotator 2 have the fixed center distance L therebetween. The tire 1c of the first rotator 1 and the tire 2c of the second rotator 2 make an elastic deformation when an empty can C or an empty PET bottle P is nipped into the nip portion 7. The tires are hard and make only a small elastic deformation, and the nip portion 7 formed by the tires can thus crush empty cans C and empty PET bottles P inside into small thicknesses. Since the center distance L remains unchanged, the restoring forces resulting from the elastic deformations of the tires 1c and 2c act as a crushing force on the empty cans C and empty PET bottles P.

The first and second rotators 1 and 2 are driven by the respective first and second drive units 9 and 10 independently. Empty cans C and empty PET bottles P nipped in the nip portion 7 undergo a crushing force from both the rotators. The two rotators are conventionally coupled to each other by means such as a gear so that the rotating force of one of the rotators is transmitted to the other rotator through the gear, with a variable center distance between the rotators. In that configuration, the center distance can increase to unmesh the gearing, failing to transmit the drive force to the other rotator if the nip portion happens to nip PET bottles which are more difficult to make elastic deformation. Such a situation does not occur in the present embodiment.

Small-diameter sprockets 9a and 10a are fixed to the output shafts of the first drive unit 9 and the second drive unit 10, respectively. Large-diameter sprockets 1d and 2d are fixed to the rotating shafts 1a and 2a, respectively. Chains 9b and 10b are wound across the small-diameter sprocket 9a and the large-diameter sprocket 1d, and across the small-diameter sprocket 10a and the large-diameter sprocket 2d, respectively. The driving forces of the first drive unit 9 and the second drive unit 10 are thereby transmitted to the first rotator 1 and the second rotator 2 with a further reduction in speed.

The first and second rotators 1 and 2 and the first and second drive units 9 and 10 are covered with an outer cover 13. Doors 13a and 13b formed in the front side can be opened to do maintenance of the first and second rotators 1 and 2 and the vicinities thereof.

Note that crushed empty cans C1 and crushed empty PET bottles P1 that are crushed and reduced in volume by the apparatus for reducing volume of a beverage container according to the present embodiment have a large difference in the crushed thickness.

Being made of aluminum or steel, empty cans C don't restore their thickness after crushed. The crushed thickness t1 is determined by factors such as the nipping pressure of the nip portion 7 or the like.

Empty PET bottles P, on the other hand, are made of a PET material. The empty PET bottles therefore restore their thickness not fully but to a thickness t2 several times the thickness t1 of the crushed empty cans even if they are once crushed by the nip portion 7 like the empty cans C to a thickness equivalent to that of the empty cans C.

The empty cans C and the empty PET bottles P loaded into the hopper 8 in succession are dropped and fed to the nip portion 7, and crushed in the nip portion 7. The empty cans C1 crushed into the thickness t1 and the empty PET bottles P1 crushed but restored to the thickness t2 several times the thickness t1 of the crushed empty cans C1 are discharged from the apparatus for reducing volume of a beverage container.

Note that the apparatus for reducing volume of a beverage container need not necessarily discharge the beverage containers directly downward. A tilt plate may be arranged under the nip portion 7 so that the crushed empty cans C1 and the crushed PET bottles P1 dropped and discharged from the nip portion 7 are turned sideways for discharge by this tilt plate.

While the engaging members 11 arranged on the outer periphery of the first rotator 1 are rod-like members laid across in the width direction of the first rotator 1, the present invention is not limited thereto. The engaging members 11 may be configured like tire chains to be put on a tire. Moreover, while the automobile tires are taken as an example of the first rotator 1 and the second rotator 2, protrusions may be arranged as the engaging members on the outer peripheries of the cylindrical rotator bodies 1b and 2b circumferentially at an appropriate pitch. An elastic body such as rubber, or one having a hardness equivalent to that of automobile tires in particular, may be formed between the protrusions so that the protrusions protrude outward from the surface of this rubber.

### Second Embodiment

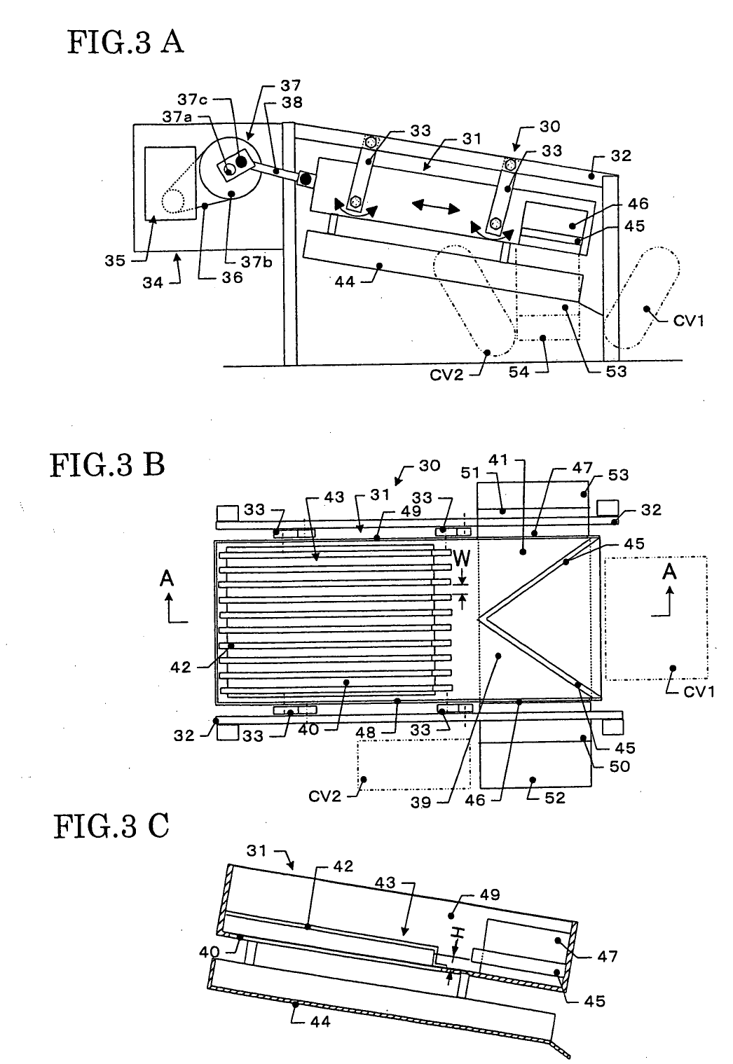

FIGS. 3A, 3B, and 3C show a second embodiment of the present invention.

FIG. 3A is a front view showing an apparatus for separating beverage containers, FIG. 3B is a plan view of the same, and FIG. 3C is a sectional view taken along the line A-A of FIG. 3B.

The apparatus 30 for separating beverage containers according to the present embodiment includes a vibrating screen 31 arranged with a slope, and is intended to separate crushed empty cans C1 and empty PET bottles P1. The crushed empty cans C1 and empty PET bottles P1 are dropped and fed from above to an upper side of the slope of the vibrating screen 31 in succession.

The vibrating screen 31 is formed in a box shape, and is swingably hung from a support frame 32 at both right and left sides via link members 33 which are arranged in the front and back, respective two positions. The vibrating screen 31 vibrates in the direction of the slope, being swung back and forth along the direction of the slope by a swing drive unit 34 which is mounted in front of the support frame 32. The swing drive unit 34 transmits the rotating force of a rotary drive unit 35, which is made of an electric motor or the like, to a pulley 37b fixed to a rotating shaft 37a of a crank mechanism 37 through a drive belt 36. A crank pin 37c of the crank mechanism 37 is coupled with the vibrating screen 31 through a coupling rod 38, so that the rotation of the crank mechanism 37 vibrates the vibrating screen 31 through the coupling rod 38.

As shown in FIG. 3B, the vibrating screen 31 has an opening 40 in its bottom 39 in the upper part of the slope, and a floor part 41 in the lower part of the slope. A screen unit 43 is arranged over the opening 40. The screen unit 43 is composed of narrow rod-like members 42 arranged in the width direction at a pitch, a screen mesh size, of W.

The rod-like members 42 which constitute the screen unit 43 are put along the direction of vibration of the vibrating screen. The screen mesh size, or the pitch W, of the rod-like member 42 is set to be greater than the thickness t1 of the crushed empty cans C1 and smaller than the thickness t2 of the crushed but restored empty PET bottles P1.

When crushed empty cans C1 and crushed empty PET bottles P1 are dropped and fed to the upper side of the slope of the vibrating screen 31, they fall onto the screen unit 43 and move downward due to the vibrations on the vibrating screen 31 along the slope direction. Here, the crushed empty cans C1 vibrate on the screen unit 43, and fall through the screen meshes of pitch W, formed between the adjoining rod-like members 42. Some of the crushed empty cans C1 can pass through the meshes directly depending on their falling positions when fed. Some can change their positions to pass through the meshes while sliding on the rod-like members 42. Some may slide over the rod-like members 42 to reach the floor part 41. It is understood that the crushed empty PET bottles P1 will simply slide over the rod-like members 42 to the floor part 41 without being screened out through the screen unit 43.

A box-shaped can receiver unit 44 for receiving empty cans C1 that fall through the screen unit 43 is integrally fixed to under the vibrating screen 31, at the same slope angle as that of the vibrating screen 31. The bottom end of the slope of the can receiver unit 44 is extended generally to the bottom position of the slope of the vibrating screen 31. The crushed empty cans C1 separated through the screen unit 43 are dropped and discharged into the can receiver unit 44, and then discharged to a transfer conveyor CV1 for transferring empty cans. The transfer conveyor CV1 is made of a chain conveyor, belt conveyor, or the like.

Weir members 45 are attached to the floor part 41 of the vibrating screen 31, at a height H from the floor surface. The height H from the floor surface for the weir members 45 to be attached to is set so that crushed empty cans C1 can slide over the floor part 41 and pass under these weir members 45, while crushed PET bottles P1 are prevented from passing.

In the present embodiment, the weir members 45 are made of angle members, for example. As shown in FIG. 3B, two weir members 45 are arranged over the floor part 41 of the vibrating screen 31 so as to spread out to the right and left, with their tops in contact with each other. Crushed empty PET bottles P1 that have slid over the rod-like members 42 of the screen unit 43 to reach the floor part 41 are guided by the weir members 45, and ejected from outlets 46 and 47 on the right and left as seen from above in the slope direction.

These right and left outlets 46 and 47 are formed in side plates 48 and 49 of the vibrating screen 31, respectively, beside the slanting weir members 45. The crushed empty cans C1 sliding over the floor part 41 in the direction of vibration are therefore not ejected from the outlet 46 or 47 but dropped and discharged from the bottom end of the slope of the vibrating screen 31. The crushed empty cans C1 dropped from the bottom end of the slope of the vibrating screen 31 fall onto the discharge end of the can receiver unit 44. The crushed empty cans C ejected to the can receiver unit 44 and the crushed empty cans C1 not passed through the screen unit 43 are thereby merged into a single flow.

In the meantime, the crushed empty PET bottles P1 that are blocked by the weir members 45 from moving to the bottom end of the slope of the vibrating screen 31 are guided to the side plates 48 and 49 by the weir members 45. The crushed empty PET bottles P1 alone are thereby discharged from the outlets 46 and 47, being separated from the crushed empty cans C1.

In the present embodiment, the two weir members 45 are arranged in a V shape. The crushed empty PET bottles P1 that are moving downward from the upper side of the slope of the vibrating screen 31 are thereby distributed to the right and left by the right and left weir members 45, and discharged from the right and left outlets 46 and 47. Nevertheless, one single weir member 45 may be arranged diagonally between the right and left side plates 48 and 49. This guides the crushed empty PET bottles P1 toward either one of the side plates along the weir member 45, and the crushed empty PET bottles are discharged from the outlet formed in that side plate.

In the present embodiment, PET bottle receivers 50 and 51 are extended horizontally sideways from the outlets 46 and 47 in the right and left side plates 48 and 49. Ducts 52 and 53 are arranged around the receivers 50 and 51 so as to extend downward. The left duct 53 is passed under the can receiver unit 44 and connected to a lower part of the right duct 52. The crushed empty PET bottles P1 passed through the right and left ducts are thereby collected into one location at the bottom of the right duct 52. The crushed empty PET bottles P1 are then discharged to a transfer conveyor CV2 for transferring empty PET bottles, which is made of a chain conveyor, a belt conveyor, or the like.

The separation apparatus 30 according to the present embodiment is intended to separate empty cans C1 and empty PET bottles P1 that are crushed in advance, by utilizing a difference occurring between the crushed thicknesses. The separation apparatus 30 is thus configured so that the screen unit 43 of the vibrating screen 31 separates the empty cans C1 of small crushed thickness from the empty PET bottles of large crushed thickness based on the difference in thickness in the width direction. This allows high speed separation of the empty cans and pet bottles, or separation targets, which are supplied in succession. While all the empty cans C1 supplied are desirably separated by the screen unit 43, some of the empty cans C1 pass over the screen unit 43 unscreened, along with the PET bottles P1. For this reason, the weir members 45 are arranged downstream so as to separate the crushed empty cans C1 and the crushed empty PET bottles P1 from each other based on a difference in the height direction this time. This also allows successive separation, thereby allowing high speed separation of the empty cans and PET bottles.

As above, empty cans and empty PET bottles have only to be moved downward from the upper side of the slope, and they can be separated by using the differences in the width and height after crushing. This allows high speed separation with a simple configuration, so that a large amount of empty cans and empty PET bottles can be separated in succession. The crushed empty cans separated may be then separated into aluminum cans and steel cans easily, for example, by using an electromagnet or the like.

That is, uncrushed empty cans and uncrushed empty PET bottles have heretofore been separated with a complicated configuration. According to the present invention, on the other hand, crushed empty cans and crushed empty PET bottles are separated with a simple configuration. This makes it possible to separate a large amount of separation targets in a short time.

Note that, for example, the foregoing transfer conveyor CV2 may be provided for each of the PET bottle receivers 50 and 51 on the right and left sides, respectively, so that the crushed empty PET bottles P1 discharged to the right and left receivers 50 and 51 are accumulated separately.

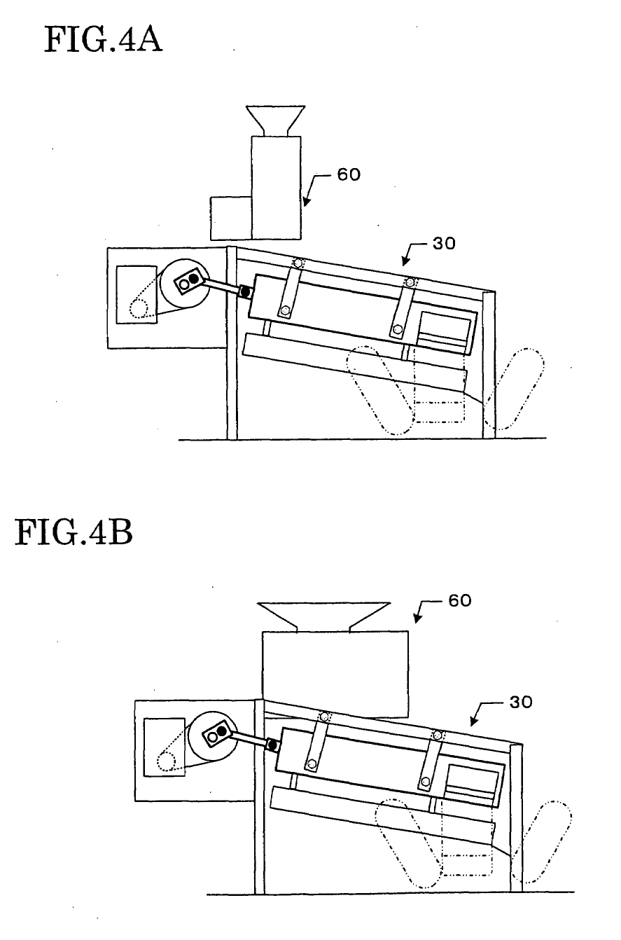

The apparatus for reducing volume of a beverage container shown in FIG. 1 may be installed over the apparatus 30 for separating beverage containers according to the present invention. If a volume reduction apparatus 60 is arranged directly above the upper side of the slope of the vibrating screen 31 as shown in FIG. 4A, the space around the separation unit 30 can be used efficiently. If the volume reduction apparatus 60 is arranged beside the upper side of the slope of the vibrating screen 31, the volume reduction apparatus 60 can be reduced in height to facilitate feeding empty cans C and empty PET bottles P into the volume reduction apparatus 60.

With the apparatus for reducing volume of a beverage container according to the foregoing first embodiment, it is possible to crush empty beverage cans and empty PET bottles, i.e., beverage containers in succession. Even when the elastic bodies of the rotators are wet with the liquid in the containers, the engaging members can surely feed the containers into the nip portion where the pair of rotators make a pressure contact. A large amount of empty beverage cans and empty PET bottles can thus be crushed in succession without container clogging or the like.

With the apparatus for separating beverage containers according to the foregoing second embodiment, crushed empty cans and crushed empty PET bottles have only to be moved over the vibrating screen downward from the top of the slope. The empty cans and the empty PET bottles can be separated from each other through the use of differences in crushed width and height therebetween. This allows high speed separation with a simple configuration, so that a large amount of empty cans and empty PET bottles can be separated in succession.

While preferred embodiments have been described, it is to be understood that modification and variation of the present invention may be made without departing from the sprit or scope of the following claims.

What is claimed is:

1. An apparatus for reducing volume of a beverage container comprising:
a pair of rotators each having a horizontal rotating shaft, the rotators being arranged with a fixed center distance between the rotating shafts so that outer peripheries thereof are in pressure contact with each other; and
a drive mechanism for driving the pair of rotators individually so as to rotate from above to below in a pressure contact area, wherein
an empty beverage container fed to the pressure contact area between the pair of rotating rotators from above is pressurized and crushed, and is dropped and discharged from the pressure contact area, and wherein
the pair of rotators have an elastic body around the rotator bodies each, and an engaging member for coming into engagement with the fed container is formed on either one of the rotators so as to protrude outward from the surface of the elastic body.

2. The apparatus for reducing volume of a beverage container according to claim 1, wherein the engaging member includes rod-like members extending in a direction of the rotating shaft, the rod-like members being circumferentially arranged at an appropriate pitch.

3. The apparatus for reducing volume of a beverage container according to claim 1, wherein the pair of rotators are automobile tires serving as the elastic body.

4. An apparatus for separating beverage containers comprising:
a vibrating screen arranged with a slope; and
an apparatus for reducing volume of a beverage container for feeding crushed and volume-reduced cans and PET bottles, or beverage containers, to the vibrating screen, the apparatus being arranged on an upper side of the slope of the vibrating screen, wherein
the vibrating screen includes:
a screen unit formed on a surface for transferring the containers to be transferred by vibration, the screen unit having screen meshes of a size such that crushed beverage cans can be passed through and crushed PET bottles cannot;
a weir member arranged on a lower side of the slope of the vibrating screen, the weir member being set to a pass height such as to allow only the crushed cans that have not fallen into the screen meshes to pass but not the crushed PET bottles, thereby guiding the not-passed PET bottles to be transferred by vibration to a side of the vibrating screen;
a can receiver unit for receiving the crushed cans passed and dropped through the screen meshes; and
an outlet for discharging the crushed PET bottles guided sideways by the weir member out of the vibrating screen.

5. The apparatus for separating beverage containers according to claim 4, comprising a vibrator unit for vibrating the vibrating screen with the slope direction as the direction of vibration.

6. The apparatus for separating beverage containers according to claim 4, wherein the screen unit of the vibrating screen is formed by arranging a plurality of transfer guide bars across an opening in parallel with each other in a width direction orthogonal to the direction of vibration transfer at the pitch of the screen meshes, the opening being formed in a bottom of a boxed-shaped screen body, the transfer guide bars extending in the direction of vibration transfer.

7. The apparatus for separating beverage containers according to claim 4, wherein the can receiver unit is arranged under the slope of the vibrating screen, and receives the crushed empty cans dropped and discharged from the lower end of the slope of the vibrating screen.

8. The apparatus for separating beverage containers according to claim 4, wherein the apparatus for reducing volume of a beverage container including:
a pair of rotators each having a horizontal rotating shaft, the rotators being arranged with a fixed center distance between the rotating shafts so that outer peripheries thereof are in pressure contact with each other; and
a drive mechanism for driving the pair of rotators individually so as to rotate from above to below in a pressure contact area, wherein
an empty beverage container fed to the pressure contact area between the pair of rotating rotators from above is pressurized and crushed, and is dropped and discharged from the pressure contact area, and wherein
the pair of rotators have an elastic body around the rotator bodies each, and an engaging member for coming into engagement with the fed container is formed on either one of the rotators so as to protrude outward from the surface of the elastic body.

9. The apparatus for separating beverage containers according to claim 8, wherein, in the apparatus for reducing volume of a beverage container, the engaging member includes rod-like members extending in a direction of the rotating shaft, the rod-like members being circumferentially arranged at an appropriate pitch.

10. The apparatus for separating beverage containers according to claim 8, wherein, in the apparatus for reducing volume of a beverage container, the pair of rotators are automobile tires serving as the elastic body.
